(19) United States
(12) Patent Application Publication
(10) Pub. No.: US 2016/0146186 A1
(43) Pub. Date: May 26, 2016

(54) SYSTEM AND METHOD FOR UPTOWER MACHINING OF A WIND TURBINE

(71) Applicant: General Electric Company, Schenectady, NY (US)

(72) Inventor: Drake Joseph Viscome, Greenville, SC (US)

(73) Assignee: General Electric Company

(21) Appl. No.: 14/548,518

(22) Filed: Nov. 20, 2014

(51) Int. Cl. F03D 1/06; F03D 7/02; B23C 1/20; F03D 11/04

(52) U.S. Cl. CPC F03D 1/0691; F03D 1/0675; F03D 11/04; F03D 7/02; B23C 1/20

(57) ABSTRACT

A method for uptower machining of a wind turbine is provided. The wind turbine includes a load control system having a plurality of load control components. The method includes the step of designating a first machining location on a rotor lock plate of the wind turbine. The first machining location is at or near an insert in the rotor lock plate. A mounting step mounts a machining device within the wind turbine proximate to the first machining location. A machining step machines the first machining location and the insert via the machining device. The machining step creates a non-flat surface at the first machining location. The non-flat surface is a substantially inductively flat surface configured for use with one or more proximity sensors in the load control system.

### FIELD OF THE INVENTION

The present disclosure relates generally to wind turbines, and more particularly to a system and method for uptower machining of a wind turbine to accommodate a load control system.

### BACKGROUND OF THE INVENTION

Wind power is considered one of the cleanest, most environmentally friendly energy sources presently available, and wind turbines have gained increased attention in this regard. Referring to FIG. 1, a modern wind turbine 10 typically includes a tower 12 with a nacelle 14 mounted thereon. A plurality of blades 16 are mounted to a rotor 18, which is in turn connected to a low speed main shaft flange 20 that turns a main rotor shaft 22. The main rotor shaft 22 is coupled to the rotor 18 by the low speed rotor lock plate 21 and is supported by the main bearing housing 24. On the opposite end, the main rotor shaft 22 is coupled to a gearbox 30 via a shrink coupling 32. The gearbox 30 is connected to a generator 15 via a high speed shaft (not shown). The generator components are supported by a bedplate 19 and may be housed within the nacelle 14.

The blades 16 convert motive force of the wind into rotational mechanical energy via the shaft 22 and gearbox 30 to generate electricity with the generator 15. Modern wind turbines 10 may also include a controller 33 centralized within the nacelle 14. Alternatively, the controller 33 may be located within any other component of the wind turbine 10 or at a location outside the wind turbine.

Many modern wind turbines employ various load control systems to reduce loads on the rotor blades and/or other wind turbine components to allow increased power production while maintaining a 20-year design life. The load control system measures stresses acting on the components via a plurality of sensors and then implements a corresponding control action when necessary, such as adjusting blade pitch.

One embodiment of a load control system for use in the wind turbine 10 is illustrated in FIG. 2. As shown, the automatic load control (ALC) system 40 typically includes a ring 43 having a plurality of brackets 41 spaced circumferentially about the ring 43 for mounting the ALC system 40 within the wind turbine 10 between the main bearing housing 24 and the rotor 18. For example, in one embodiment, the brackets 41 may be mounted on the main bearing housing 24 of the wind turbine 10. Further, as mentioned, the ALC system 40 may include one or more sensors 42 spaced circumferentially about the ring 43.

To accommodate the ALC system, many wind turbines employ a specially designed rotor lock plate 21 such that the system 40 can obtain sensor measurements from the main shaft flange 20. Conventional wind turbines, however, must be retro-fitted to accommodate the ALC system because conventional rotor lock plates 21 do not have comparable tolerances to the main shaft flange 20. In some applications, inserts are installed between the rotor lock plate halves. The inserts provide a continuous axial facing surface that can be used with proximity sensors. However, even though the axial facing surface is mechanically flat, the proximity sensors detect a “non-flat” surface. The detected non-flat surface causes errors and non-desired behavior in the ALC system.

Thus, an improved system and method for retro-fitting an existing wind turbine with an ALC system would be desired in the art. For example, a system and method that provided uptower machining to accommodate the ALC system would be advantageous.

### BRIEF DESCRIPTION OF THE INVENTION

Aspects and advantages of the invention will be set forth in part in the following description, or may be obvious from the description, or may be learned through practice of the invention.

According to one aspect of the present invention, a method for uptower machining of a wind turbine is provided. The wind turbine includes a load control system having a plurality of load control components. The method includes the step of designating a first machining location on a rotor lock plate of the wind turbine. The first machining location is at or near an insert in the rotor lock plate. A mounting step mounts a machining device within the wind turbine proximate to the first machining location. A machining step machines the first machining location and the insert via the machining device. The machining step creates a non-flat surface at the first machining location. The non-flat surface is a substantially inductively flat surface configured for use with one or more proximity sensors in the load control system.

According to another aspect of the present invention, a machining system for up-tower machining of a wind turbine to accommodate a load control system is provided. The machining device includes a mountable body configured to mount within the wind turbine proximate to a first machining location on a rotor lock plate of the wind turbine. The first machining location is at or near an insert in the rotor lock plate. A milling tool is configured for machining the insert and an area of the rotor lock plate near the insert. The milling tool includes a track follower configured to move along a surface of the main shaft. The track follower includes a spring connection. The milling tool is configured to create a non-flat surface at the first machining location.

According to yet another aspect of the present invention, a wind turbine includes a tower, a nacelle mounted on the tower, and a rotor having a plurality of blades. The rotor is connected to the nacelle. A rotor lock plate is connected to the rotor, and the rotor lock plate is configured to rotate with the rotor. The rotor lock plate includes at least one insert located at a seam of the rotor lock plate. A mechanically non-flat surface is formed in an area including the insert and the area near the insert in the rotor lock plate. The non-flat surface is a substantially inductively flat surface configured for use with one or more proximity sensors in a load control system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a modern wind turbine;

FIG. 2 illustrates a perspective view of one embodiment of an Advanced Load Control (ALC) system configured for a modern wind turbine;

FIG. 3 illustrates a perspective view of generator of a wind turbine including one embodiment of a machining device for uptower machining of the wind turbine to accommodate an ALC system according to the present invention;

FIG. 4 illustrates a top view of the embodiment of FIG. 3;

FIG. 5 illustrates a side view of the embodiment of FIG. 3;

FIG. 6 illustrates a conventional rotor lock plate before machining operations according to the present invention;

FIG. 7 illustrates a conventional rotor lock plate after some machining operations according to the present invention;

FIG. 8 illustrates a cross-sectional view of the rotor lock plate FIG. 7 along line A-A;

FIG. 9 illustrates a top view of a generator of a wind turbine including another embodiment of a machining device for uptower machining of the wind turbine to accommodate ALC according to the present invention;

FIG. 10 illustrates a side view of the embodiment of FIG. 9;

FIG. 11 illustrates a system for uptower machining of the wind turbine to accommodate ALC according to the present invention;

FIG. 12 illustrates a method for uptower machining of a wind turbine to accommodate an ALC system according to the present invention;

FIG. 13 illustrates a cross-sectional view of a machining location, according to an aspect of the present invention;

FIG. 14 illustrates a cross-sectional view of a machining location, according to an aspect of the present invention; and

FIG. 15 illustrates a cross-sectional view of a machining location, according to an aspect of the present invention.

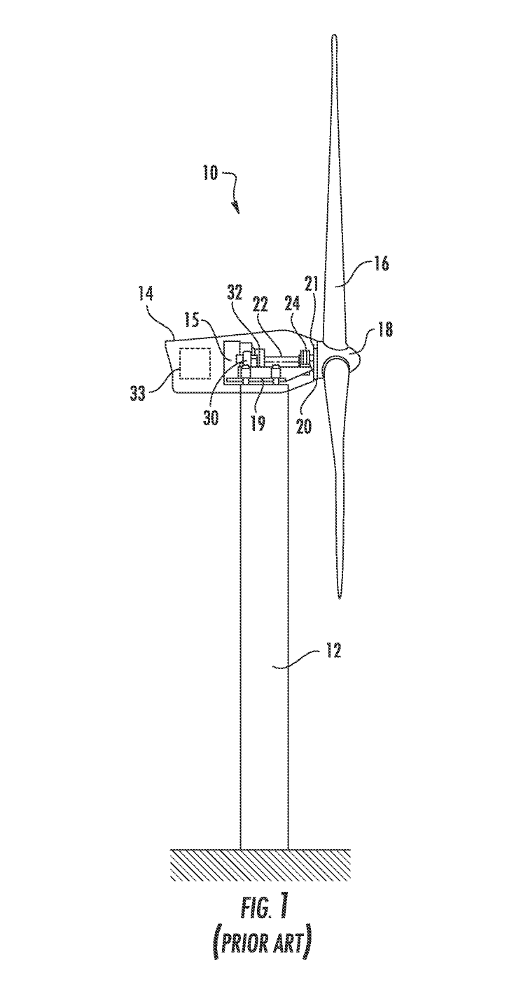

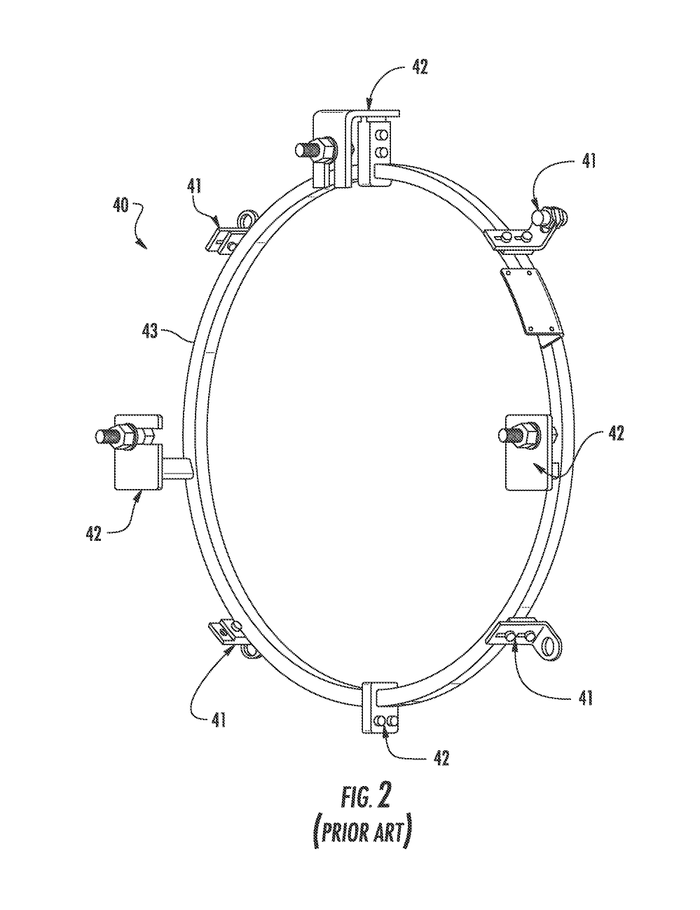

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for uptower machining of a wind turbine to accommodate a load control system configured to reduce loads acting on various wind turbine components. For example, in one embodiment, the load control system is an Advanced Load Controls (ALC) system by General Electric Company. In one embodiment, the present disclosure includes a machining device having a mountable body, a securing device, and a milling tool. As such, the machining device is capable of performing a variety of machining operations to the rotor lock plate and insert locations of the wind turbine, including, but not limited to, drilling, boring, grinding, milling, and/or similar.

The mountable body is configured to mount to any suitable location within the wind turbine, such as a main bearing housing so as to be proximate to a machining location on the rotor lock plate. The securing device is configured to secure the machining device to the main bearing housing and/or the rotor lock plate. By temporarily securing the machining device to the rotor lock plate during particular machining operations, the drilling tool is capable of drilling one or more circular holes in the rotor lock plate that are not elongated due to backlash in the drivetrain during operation of the wind turbine. By securing the machining device to the main bearing housing during machining operations, the milling tool provides more precise and accurate machining of the rotor lock plate. As such, the machining device is capable of machining the insert locations and the rotor lock plate such that the rotor lock plate emulates the main shaft flange of the rotor.

The system may also include a torque device for rotating the rotor before, during, and/or after various machining operations. As such, the rotor lock plate may be rotated such that the machining device can remain stationary but may still machine one or more desired machining locations. In addition, the present system may include a monitoring system for monitoring machining operations and a controller for controlling such operations. As such, the rotor lock plate and inserts may be machined until predetermined tolerances or geometries are achieved at which time the monitoring system can send a signal to the controller to stop machining operations.

The present system and method includes many advantages not present in the prior art. For example, the present machining device and process may advantageously provide for accurate and efficient machining of the rotor lock plate up-tower in the wind turbine such that any suitable load control system can be retro-fitted therein. As such, when the load control system (e.g. the ALC system) is retro-fitted within conventional wind turbines, a plurality of sensors (e.g. proximity sensors) can obtain accurate measurements from the rotor lock plate instead of the main shaft flange. As such, machining the wind turbine uptower provides substantial cost savings and reduced installation time.

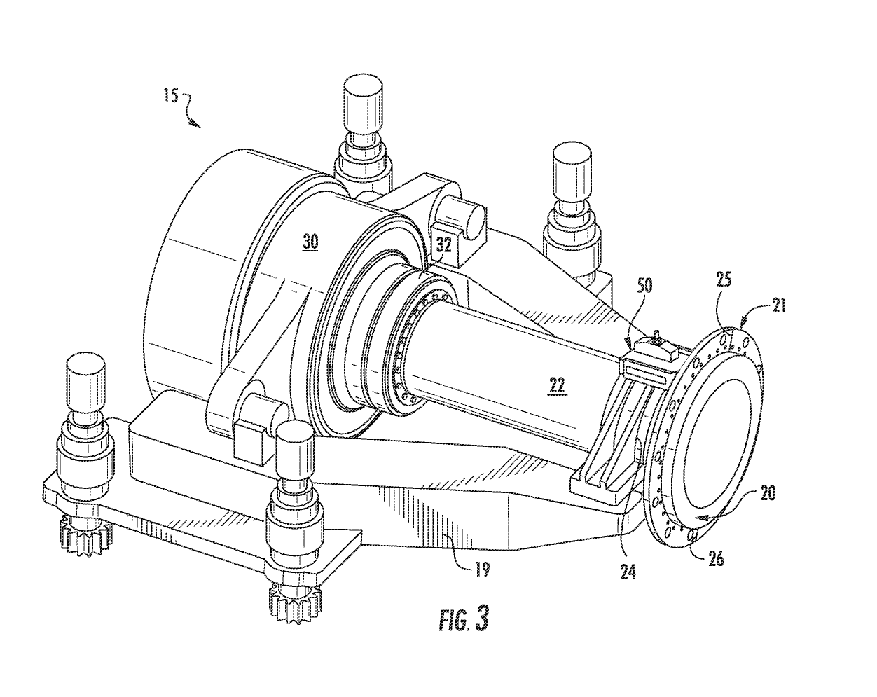

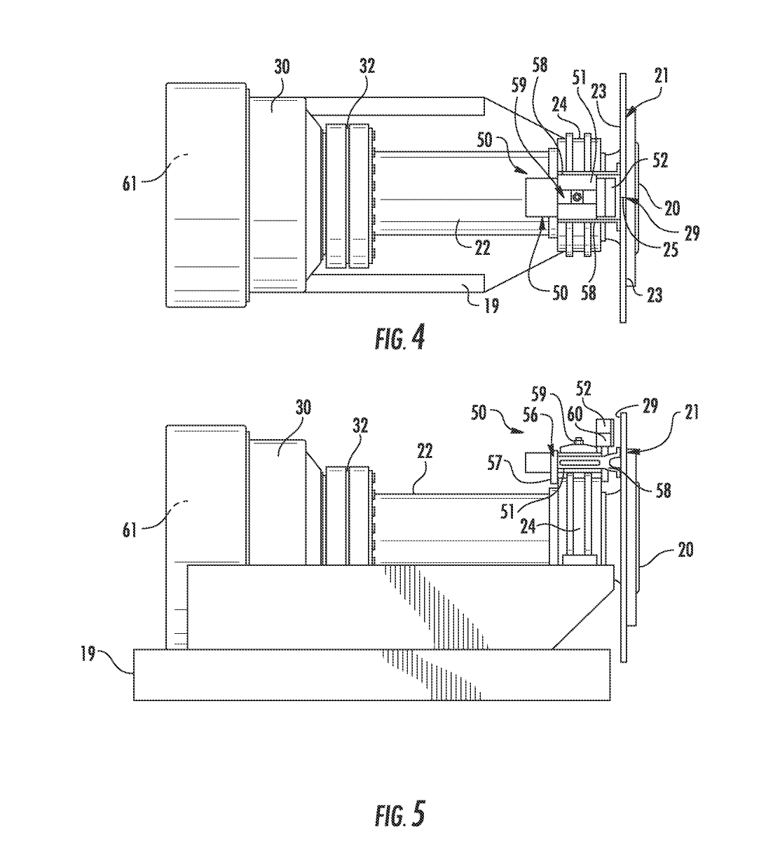

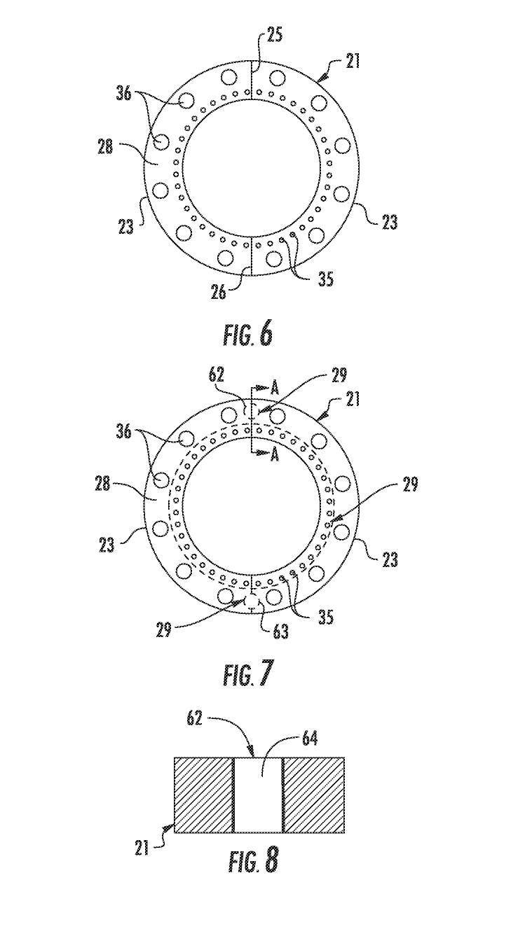

Referring now to the drawings, FIG. 3 illustrates a perspective view of one embodiment of the wind turbine generator drivetrain 15 including a machining device 50 according to the present disclosure; FIG. 4 illustrates a top view of the embodiment of FIG. 3; and FIG. 5 illustrates a side view of the embodiment of FIG. 3. As shown, the machining device 50 is typically mounted in the wind turbine 10 proximate to at least one desired machining location 29. For example, as shown, the machining location 29 may be a seam 25 between two rotor lock plate segments 23 of the rotor lock plate 21, or an insert located between two rotor lock plate segments. Additionally, the machining location 29 may be an interior surface 28 of the rotor lock plate 21 (FIGS. 6 and 7). In further embodiments, the machining location 29 may be any suitable location on the rotor lock plate 21 such that machining of the rotor lock plate 21 emulates the main shaft flange 20. Alternatively, the machining location 29 may be any other area within the wind turbine so as to accommodate the load control system.

Referring particularly to FIGS. 4 and 5, the machining device 50 generally includes a mountable body 51 configured to mount within the wind turbine 10. For example, in one embodiment, the mountable body 51 is configured to mount to the main bearing housing 24 proximate to the desired machining location 29 on the rotor lock plate 21. The mountable body 51 may be any suitable surface, platform, or housing on which to place or house various components of the machining device 50. For example, in some embodiments, the mountable body 51 has a generally planar work surface. In other embodiments, the mountable body 51 may have any suitably contoured work surface or surfaces.

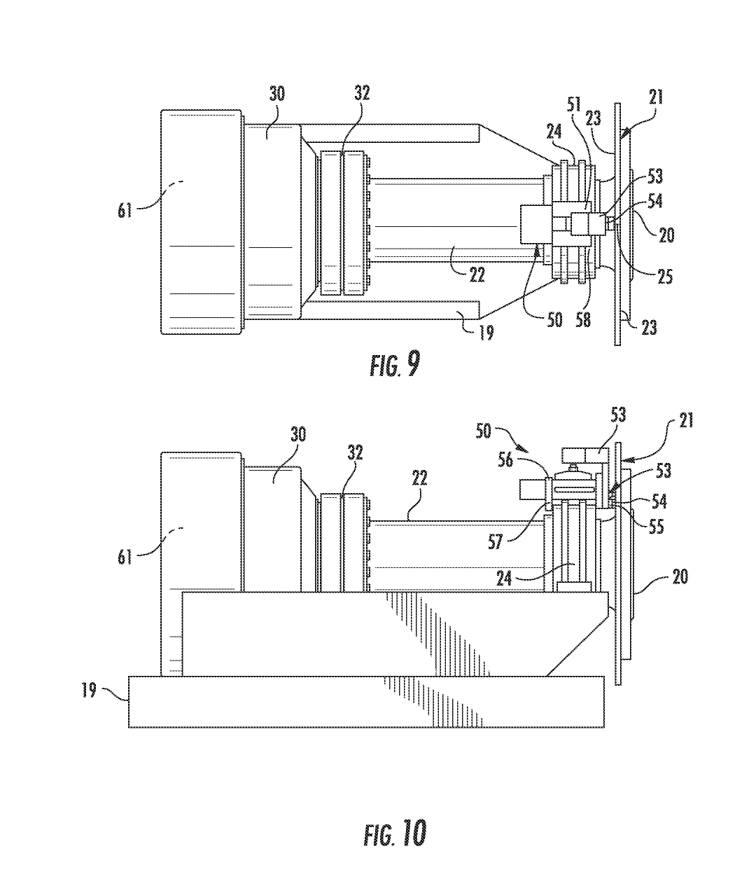

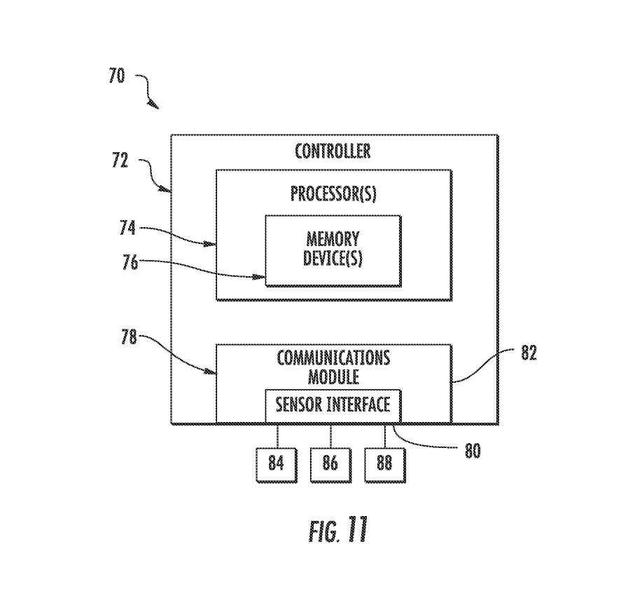

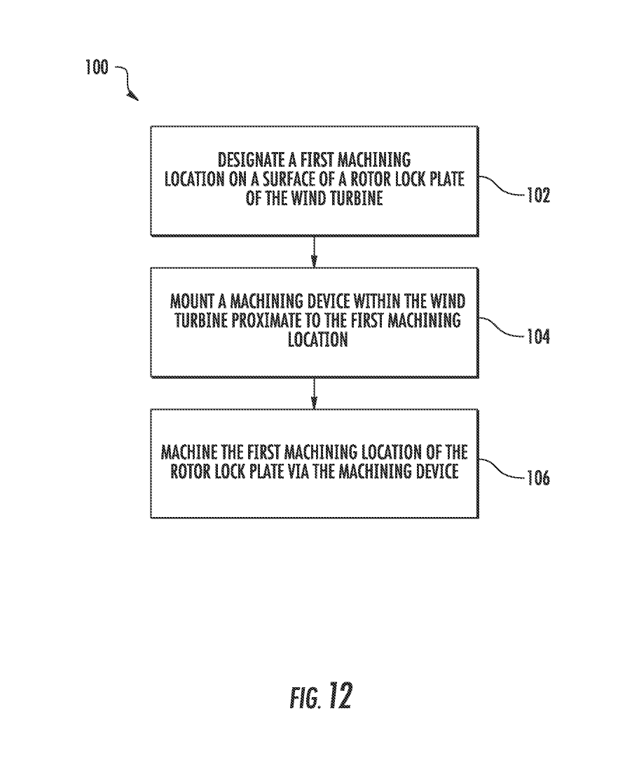

The machining device 50 may also include a drilling or boring tool 52 configured for drilling the machining location 29 on the rotor lock plate 21. For example, in one embodiment, the drilling tool 52 is configured to drill a hole in the rotor lock plate 21. As such, the drilling took 52 may be a drill press, a drill bit, an end mill, or any suitable drilling tool for machining a hole. Further, the machining device 50 may include a milling tool 53, such as a mill press, configured for milling the machining location 29 (FIGS. 9 and 10) or the insert and the area of the rotor lock plate near the insert. Referring to FIGS. 9 and 10, the milling tool 53 may also include a track follower 54, such as a cam follower. For example, the track follower 54 typically includes a shaft and an end follower. The shaft is connected to the mountable body and is configured to extend toward the machining location. The end follower is configured to move along a surface of the machining location during various machining operations. For example, the end follower may be configured to move along an interior surface of the main shaft 22 during machining operations. Further, the end follower may have a variety of shapes. For example, the end follower may have a roller shape, a mushroom shape, a flat-faced shape, or similar. In additional embodiments, the track follower 54 may include a spring connection 55. The spring connection 55 allows for more accurate machining of the machining location within the wind turbine since many of the machined areas are moving due to normal wind turbine operation. As such, the spring connection 55 is configured to prevent tool and/or plate damage. For example, the track follower 54 can push-back on the spring connection 55 as needed. It should be understood, however, that the machining device 50 is not limited to milling and drilling, but may be configured for any suitable machining operation.

The machining device 50 may also include one or more securing devices 56 configured to secure the machining device 50 within the wind turbine 10. The securing device(s) 56 may include any suitable clamp, vice device, flanges, or other suitable securing device, and combinations thereof. For example, in the illustrated embodiment of FIGS. 4 and 5, the securing device 56 includes a clamp 57 configured to secure the machining device 50 to the main bearing housing 24. Further, the securing device 56 includes a plurality of removable flanges 58 configured to secure the machining device 50 to the rotor lock plate 21. The clamp 57 is typically secured to the main bearing housing 24 by being brought into communication with the main bearing housing 24 and tightened around the housing to hold the machining device 50 in a generally stationary position. Additionally, the removable flanges 58 are typically secured to the rotor lock plate 21 by being brought into communication with an interior surface 28 of the rotor lock plate 21 and bolted to plate. For example, as shown, a plurality of removable flanges 58 are secured to the sides of the mountable body 51 of the machining device 50 and to the interior surface 28 of the rotor lock plate 21. Such a configuration secures the machining device 50 such that it is capable of drilling a hole that is circular and not elongated due to backlash in the drivetrain. The machining device 50 may also be configured to machine a non-flat surface at the location of the inserts and the area of the rotor lock plate near or surrounding the inserts. The securing device 56 may also include an adjustment device 59 such that the machining device 50 may be secured to various components of the wind turbine 10 having different sizes.

In a further embodiment, the machining device 50 may also include a designation device 60 configured to designate the desired machining location 29 on the rotor lock plate 21. The designation device 60 may, in some embodiments, be a center punch. Alternatively, the designation device 60 may be any suitable rod, light locating device or laser locating device (such as a precision laser beam), or other suitable tool for designating a machining location 29 as described herein. Additionally or alternatively, a separate device may be utilized to mark the desired machining location 29. For example, a marker, such as a pen or pencil, a separate punching device, or another suitable marking device, may be utilized to mark the desired machining location 29.

In still another embodiment, the machining device 50 may also include a torque device 61 configured to rotate the rotor 18, which also rotates the rotor lock plate 21. In one embodiment, for example, the torque device 61 may include a motor and pinion gear that is mounted to the high speed brake disc bracket (located near the generator 30). As such, the pinion gear meshes with the high speed brake disc and the motor drives rotation of the drivetrain. More specifically, the motor may be coupled to the torque device 61 such that the motor imparts mechanical force to the torque device 61. Similarly, the torque device 61 may be coupled to the pinion which may, in turn, be in rotational engagement with the gearbox 30 such that rotation of the pinion causes rotation of the rotor 18. Thus, in such embodiments, rotation of the motor drives the pinion and the gearbox 30, thereby rotating the rotor 18 and the rotor lock plate 21. It should be understood that the motor may be any suitable electric, hydraulic, or pneumatic motor known in the art.

As mentioned, the machining device 50 is configured to perform a plurality of machining operations to the wind turbine 10 so as to accommodate the load control system, such as ALC system 40. For example, in one embodiment, the machining device 50 may be configured to machine the rotor lock plate in one or more locations. As such, the machining device 50 is first secured to a fixed location in the wind turbine 10. For example, as shown in the illustrated embodiment of FIGS. 3-5, the machining device 50 is secured atop the main bearing housing 24. If the rotor lock plate 21 includes multiple segments 23 joined together at one or more seams 25, 26 (FIGS. 6 and 7), the machining device 50 may also be secured to the rotor lock plate 21 using one or more removable flanges 58.

After the machining device 50 is secured, the machining device 50 is configured to machine a first machining location 29. For example, in the embodiment shown in FIGS. 3-7, the first machining location 29 on the rotor lock plate 21 is the first seam 25 on the rotor lock plate 21. The seams 25, 26 of the rotor lock plate 21 can be important machining locations due to potential interference with the sensor measurements of the load control system 40 caused by potential voids in the seams 25, 26. As such, the machining device 50 is capable of machining the seams 25, 26 such that any voids are filled. For example, the drilling tool 52 is configured to drill a first and second hole 62, 63 through the first and second seams 25, 26 respectively (FIG. 7). Additionally, the machining device 50 is configured to fill the drilled hole(s) 62, 63 with a filler or insert 64, as illustrated in the cross-sectional view of FIG. 8, depicting the first seam 25 along line A-A. It should be understood that the insert 64 can be any suitable filling or plug known in the art. For example, in one embodiment, the insert 64 may include a steel plug. In a further embodiment, the insert 64 may include a steel plug with a press fit adhesive. In still additional embodiments, the insert 64 may be a tapped plug or a tapered plug.

In one embodiment, e.g. wherein the rotor lock plate 21 has two seams, the removable flanges 58 can be temporarily removed from the rotor lock plate 21 after the first hole 62 is drilled, filled, and cured (if necessary). As such, the torque device 61 may rotate the rotor 18 (and corresponding rotor lock plate 21) such that the second seam 26 is rotated 180 degrees into the machining position 29. The machining device 50 is then configured to repeat the machining process for the second seam 26 by drilling a hole through the second seam 26 and filling the hole 62 with an appropriate insert 64 as described above in regards to the first seam 25.

In further embodiments, and if necessary, the removable flanges 58 can be uninstalled from the rotor lock plate 21 before further machining is implemented, as shown in FIGS. 9 and 10. As such, in one embodiment, the only securing device 56 that remains installed for further machining operations is the clamp 57 between the machining device 50 and the main bearing housing 24. Such a configuration allows for free rotation of the rotor lock plate 21 by the torque device 61 for the remaining machining operations. As such, in one embodiment, as shown in FIGS. 9 and 10, the milling tool 43 is configured to mill the interior surface 28 of the rotor lock plate 21. More specifically, the torque device 61 of the milling tool 53 rotates the rotor lock plate 21 such that the milling tool 53 and track follower 54 continuously and uniformly face mills at least a portion of the interior surface 28 of the rotor lock plate 21 to emulate the main shaft flange 20. Further, the spring connection 55 of the track follower 54 allows for face milling of the rotor lock plate 21, but allows the track follower 54 to push-back on the spring connection 55 as needed to avoid tool and/or plate damage during normal operation of the wind turbine.

Referring now to FIG. 11, there is illustrated a block diagram of one embodiment of a system 70 according to the present disclosure. As mentioned, the machining device 50 may be part of the larger system 70 for machining the wind turbine uptower to accommodate the load control system 40. As such, the system 70 may include the machining device 50 described herein, a monitoring system 78, and a controller 72. The monitoring system 78 is configured to monitor the machining device 50 during the various machining operations. In one embodiment, for example, the monitoring system 78 may include a plurality of sensors 84, 86, 88. The plurality of sensors 84, 86, 88 may be any suitable sensors known in the art. For example, in one embodiment, the plurality of sensors includes proximity sensors and/or analog indicative sensors. Thus, the sensors may, for example, be used to generate signals relating to the machining of the rotor lock plate 21, which can then be utilized by the controller 72 to determine whether machining should stop or continue.

More specifically, the controller 72 may include one or more processor(s) 74 and associated memory device(s) 76 configured to perform a variety of computer-implemented functions (e.g., performing the methods, steps, calculations and the like and storing relevant data as disclosed herein). The monitoring system 78 may also include a communications module 82 to facilitate communications between the controller 72 and the various components of the wind turbine 10. Further, the communications module 82 may include a sensor interface 80 (e.g., one or more analog-to-digital converters) to permit signals transmitted from the sensors 84, 86, 88 to be converted into signals that can be understood and processed by the processors 74. It should be appreciated that the sensors 84, 86, 88 may be communicatively coupled to the communications module 82 using any suitable means. For example, as shown in FIG. 11, the sensors 84, 86, 88 are coupled to the sensor interface 80 via a wired connection. However, in other embodiments, the sensors 84, 86, 88 may be coupled to the sensor interface 80 via a wireless connection, such as by using any suitable wireless communications protocol known in the art. As such, the processor 74 may be configured to receive one or more signals from the sensors 84, 86, 88. Accordingly, the controller 72 is configured to control operation of the machining device 50 and the monitoring system 78.

Referring now to FIG. 12, a method 100 for uptower machining of a wind turbine to accommodate the load control system having a plurality of load control components is illustrated. The method 100 includes a step 102 of designating a first machining location on a surface of a rotor lock plate of the wind turbine. The first machining location is at or near an insert 64 in the rotor lock plate. As mentioned, the machining location may be an insert 64 at a seam between at least two rotor lock plate segments, or an area of the rotor lock plate near or surrounding the insert 64, or any other suitable location within the wind turbine. The method 100 also includes a step 104 of mounting a machining device within the wind turbine proximate to the first machining location. In one embodiment, the step 104 of mounting further includes mounting the machining device atop a radial exterior surface of the main bearing housing proximate to the machining location. The method 100 may also include securing the machining device to the rotor lock plate. In a further embodiment, the step of securing the machining device to the rotor lock plate may further include securing the machining device to the rotor lock plate using one or more removable side flanges.

A next step 106 includes machining the first machining location and the insert 64 of the rotor lock plate via the machining device. The machining step 106 creates a non-flat surface at the first machining location. It has been discovered that sub-surface discontinuities exist between the insert 64 and the rotor lock plate 21. Proximity sensors 42 have inductive properties and the sensors 42 read the mechanically flat surface of the insert and surrounding area of the rotor lock plate as a non-flat surface. This causes problems for the load control system, as it tries to compensate for non-existent rotor load variations. The axial facing surface of the rotor lock plate and insert are mechanically flat, but the proximity sensor reads a distance variation (which translates into a phantom rotor load). To compensate for this problem, an aspect of the present invention takes the non-intuitive approach of machining a non-flat surface, with respect to the majority of the axial face of the rotor lock plate, at the insert location and in the area surrounding or near the inserts 64. Depressions are formed in both the insert and rotor lock plate by machining down the respective surfaces. These depressions (or amount of material machined away) are configured to return a substantially or effectively flat surface when detected by the proximity sensors 42. The designating step 102 and machining step 106 are repeated at every insert location.

The step 106 of machining may optionally include, after securing the machining device to the rotor lock plate, machining one or more seams of the rotor lock plate. In one embodiment, machining the one or more seams may include drilling a hole through the seam and filling the hole with an insert 64. In a further embodiment, the step of machining may include machining an interior surface of the rotor lock plate.

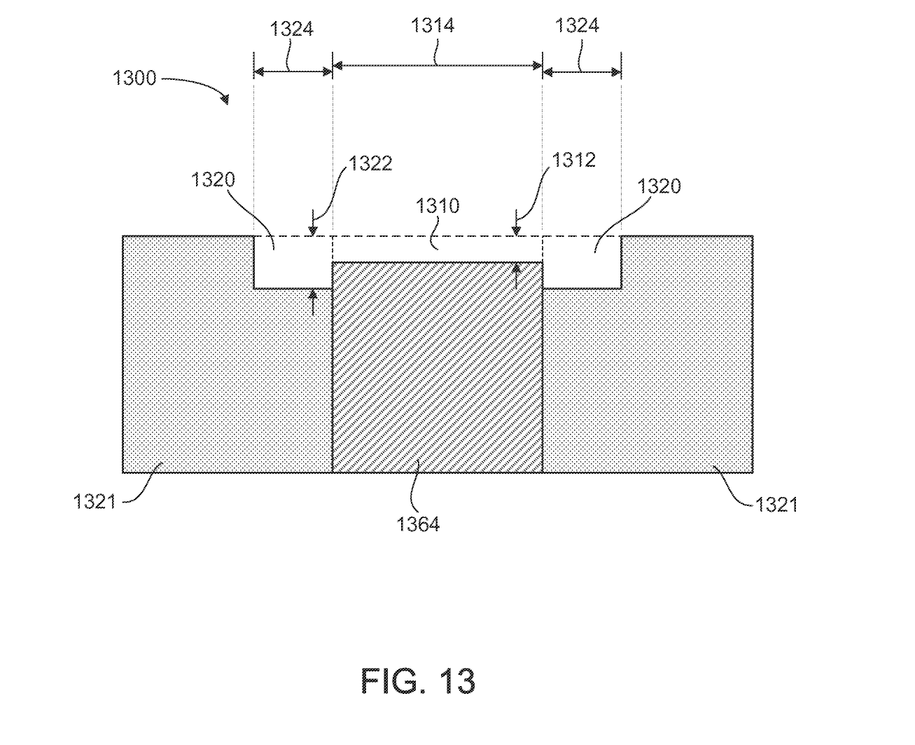

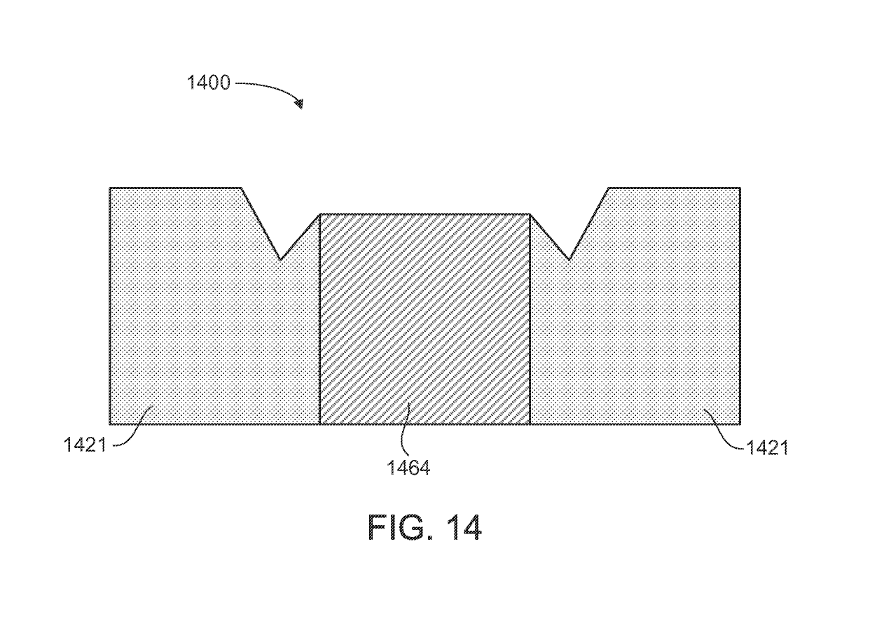

FIG. 13 illustrates a cross-sectional view of a machining location 1300, according to an aspect of the present invention. The machining location 1300 is on the rotor lock plate 1321 and includes the insert 1364. FIG. 8 illustrates a similar view, but before machining is complete. The milling tool 53 is used to create depressions at the machining location 1300, or in other words, the milling tool selectively removes material to leave depressions having a specific shape, width and depth. The geometry of the resulting surface (or depression) is configured to make a mechanically non-flat surface at location 1300, but to return a substantially flat surface reading when detected by proximity sensors 42. The load control system is configured so that the signal from the proximity sensors 42 has certain predetermined envelopes where no action is taken. As one example only, if the proximity sensors return a distance variation of 2 mm or less, then no action is taken by the load control system. Conversely, if the distance variation exceeds more than 2 mm, then the load control system may activate various systems to compensate (e.g., by changing the pitch of the blades).

To create the non-flat surface, the milling tool 53 removes material as indicated by the dotted lines. The depression 1310 formed in the insert is a generally cylindrical depression in that all the material is removed down to a specific distance. The depression 1320 is formed in the rotor lock plate 1321 in the area adjacent to the insert 1364. Depression 1320 is a generally circular trench having a rectangular cross-section. The depth 1322 of depression 1320 is greater than the depth 1312 of depression 1310, or the surface of the insert is higher than the bottom of the circular trench. The resulting surface, formed by depressions 1310 and 1320, is configured to provide a substantially (or effectively) inductively flat surface to compensate for sub-surface discontinuities between the rotor lock plate 1321 and the insert 1364. As an example only, the depth 1322 of depression 1320 may be about 2 to about 5 times the depth 1312 of depression 1310. If depression 1310 was 0.5 mm deep than the depth of depression 1320 might be about 1 mm to about 2.5 mm. The width 1314 of depression 1310 may be about 1 to about 6 times greater than the width 1324 of depression 1320. If the width 1314 (e.g., diameter) of depression 1310 was 60 mm, than the width 1324 of depression 1320 might be about 10 mm to about 60 mm. Depression 1320 takes the form of an annular or circular trench which encircles the insert 1364 (or depression 1310).

FIG. 14 illustrates a cross-sectional view of a machining location 1400, according to an aspect of the present invention. The machining location 1400 is on the rotor lock plate 1421 and includes the insert 1464. In this example the depression formed in the rotor lock plate 1421 is a generally circular trench having a triangular cross-section. The depression formed over the insert 1464 is the same as in FIG. 13, which is a generally cylindrical depression.

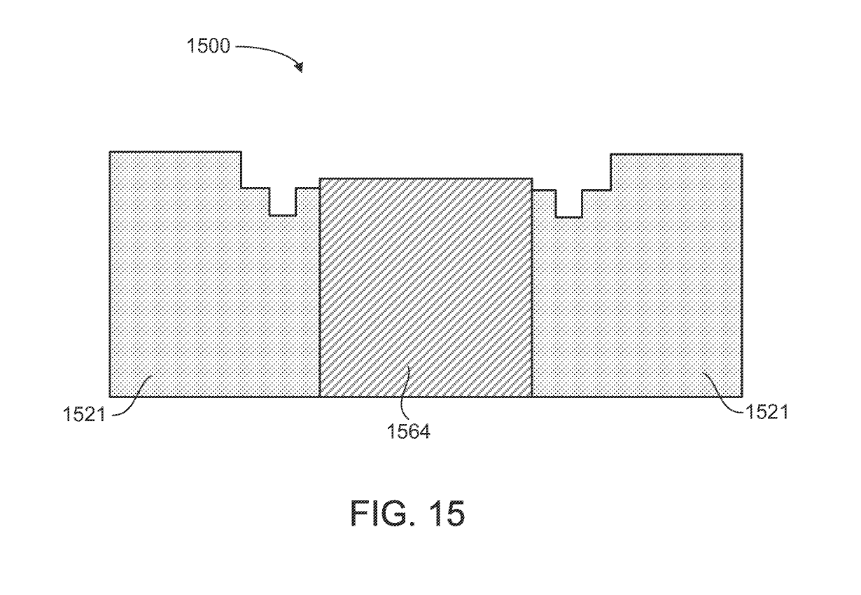

FIG. 15 illustrates a cross-sectional view of a machining location 1500, according to an aspect of the present invention. The machining location 1500 is on the rotor lock plate 1521 and includes the insert 1564. In this example the depression formed in the rotor lock plate 1521 is a generally circular trench having a polygonal cross-section. The depression formed over the insert 1564 is the same as in FIGS. 13 and 14, which is a generally cylindrical depression. In FIGS. 13-15, it can be seen that the surface of insert is lowered with respect to the majority of the rotor lock plate surface. The rotor lock plate surface near the insert is lowered even further, and the resulting non-flat surface helps to compensate for the sub-surface discontinuities when scanned by the proximity sensors. The resulting non-flat surface at and near the inserts provide a much “flatter” response for the proximity sensors and the resulting proximity signal is within the threshold envelope for no action by the load control system. This assumes that the remainder of the rotor lock plate is also within the threshold envelope for no action by the load control system. If the rotor lock plate displaces more than a predetermined amount, indicating a substantive load on the rotor, then the load control system will operate normally and activate the appropriate components and systems to reduce rotor loads.

According to an aspect of the present invention, a wind turbine includes the machined non-flat area in the rotor lock plate. The wind turbine includes a tower, a nacelle mounted on the tower, and a rotor having a plurality of blades. The rotor is connected to the nacelle. A rotor lock plate is connected to the rotor, and the rotor lock plate is configured to rotate with the rotor. The rotor lock plate including at least one insert located at a seam of the rotor lock plate. A mechanically or physically non-flat surface is formed in an area including the insert and the area near the insert in the rotor lock plate. The non-flat surface is a substantially inductively flat surface configured for use with one or more proximity sensors in a load control system. The non-flat surface is non-flat with respect to the majority of the axial surface of the rotor lock plate.

The non-flat surface includes a plurality of depressions including a first depression formed in the rotor lock plate adjacent to the insert. The first depression has a first depth. A second depression is formed in the insert, and the second depression has a second depth. The first depth is greater than the second depth, and both the first depression and the second depression are configured to provide a substantially inductively flat surface to compensate for sub-surface discontinuities between the rotor lock plate and the insert. The second depression may be formed of a generally cylindrical depression and the first depression is formed of at least one of, a generally circular trench having a rectangular cross-section, a generally circular trench having a triangular cross-section, or a generally circular trench having a polygonal cross-section. The first depth may be about 2 to about 5 times the second depth. A width of the second depression may be about 1 to about 6 times greater than a width of the first depression.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for uptower machining of a wind turbine, the wind turbine including a load control system comprising a plurality of load control components, the method comprising:
designating a first machining location on a rotor lock plate of the wind turbine, the first machining location being at or near an insert in the rotor lock plate;
mounting a machining device within the wind turbine proximate to the first machining location;
machining the first machining location and the insert via the machining device; and
wherein the machining step creates a non-flat surface at the first machining location, and the non-flat surface is a substantially inductively flat surface configured for use with one or more proximity sensors in the load control system.

2. The method of claim 1, wherein the non-flat surface includes a plurality of depressions comprising:
a first depression formed in the rotor lock plate adjacent to the insert, the first depression having a first depth;
a second depression formed in the insert, the second depression having a second depth; and
wherein the first depth is greater than the second depth, and both the first depression and the second depression are configured to provide a substantially inductively flat surface to compensate for sub-surface discontinuities between the rotor lock plate and the insert.

3. The method of claim 2, wherein the first depth is about 2 to about 5 times the second depth.

4. The method of claim 2, wherein a width of the second depression is about 1 to about 6 times greater than a width of the first depression.

5. The method of claim 2, wherein the second depression is formed of a generally cylindrical depression and the first depression is formed of at least one of:
a generally circular trench having a rectangular cross-section;
a generally circular trench having a triangular cross-section; or
a generally circular trench having a polygonal cross-section.

6. The method of claim 3, further comprising:
repeating the designating step and the machining step at every insert location.

7. A machining system for uptower machining of a wind turbine to accommodate a load control system, the machining device comprising:
a mountable body configured to mount within the wind turbine proximate to a first machining location on a rotor lock plate of the wind turbine, the first machining location being at or near an insert in the rotor lock plate;
a milling tool configured for machining the insert and an area of the rotor lock plate near the insert, the milling tool comprising a track follower configured to move along a surface of the main shaft, the track follower comprising a spring connection; and
wherein the milling tool is configured to create a non-flat surface at the first machining location.

8. The machining system of claim 7, further comprising a securing device, the securing device configured to secure the machining device to a main bearing housing within the wind turbine.

9. The machining system of claim 8, wherein the securing device is further configured to secure the machining device to the rotor lock plate.

10. The machining system of claim 7, wherein the non-flat surface is a substantially inductively flat surface, the inductively flat surface configured for use with one or more proximity sensors in the load control system.

11. The machining system of claim 10, wherein the non-flat surface includes a plurality of depressions comprising:
a first depression formed in the rotor lock plate adjacent to the insert, the first depression having a first depth;
a second depression formed in the insert, the second depression having a second depth; and
wherein the first depth is greater than the second depth, and both the first depression and the second depression are configured to provide a substantially inductively flat surface to compensate for sub-surface discontinuities between the rotor lock plate and the insert.

12. The machining system of claim 10, wherein the first depth is about 2 to about 5 times the second depth.

13. The machining system of claim 10, wherein a width of the second depression is about 1 to about 6 times greater than a width of the first depression.

14. The machining system of claim 10, wherein the first depression is formed of a generally circular trench having a rectangular cross-section, and the second depression is formed of a generally cylindrical depression.

15. The machining system of claim 10, wherein the first depression is formed of a generally circular trench having a triangular cross-section, and the second depression is formed of a generally cylindrical depression.

16. The machining system of claim 10, wherein the first depression is formed of a generally circular trench having a polygonal cross-section, and the second depression is formed of a generally cylindrical depression.

17. A wind turbine comprising:
a tower;
a nacelle mounted on the tower;
a rotor having a plurality of blades, the rotor connected to the nacelle;
a rotor lock plate connected to the rotor, the rotor lock plate configured to rotate with the rotor, the rotor lock plate including at least one insert located at a seam of the rotor lock plate; and
wherein a non-flat surface is formed in an area including the insert and the area near the insert in the rotor lock plate, the non-flat surface is a substantially inductively flat surface configured for use with one or more proximity sensors in a load control system.

18. The wind turbine of claim 17, wherein the non-flat surface includes a plurality of depressions comprising:
a first depression formed in the rotor lock plate adjacent to the insert, the first depression having a first depth;
a second depression formed in the insert, the second depression having a second depth; and
wherein the first depth is greater than the second depth, and both the first depression and the second depression are configured to provide a substantially inductively flat surface to compensate for sub-surface discontinuities between the rotor lock plate and the insert.

19. The wind turbine of claim 18, wherein the second depression is formed of a generally cylindrical depression and the first depression is formed of at least one of:
a generally circular trench having a rectangular cross-section;
a generally circular trench having a triangular cross-section; or
a generally circular trench having a polygonal cross-section.

20. The wind turbine of claim 19, wherein the first depth is about 2 to about 5 times the second depth, and a width of the second depression is about 1 to about 6 times greater than a width of the first depression.
